(19) United States
(12) Patent Application Publication
(10) Pub. No.: US 2004/0091841 A1
(43) Pub. Date: May 13, 2004

(54) Methods for improving an organization using cultural characteristics defined by leadership from customer research

(75) Inventors: Darin W. Buchtel, Boulder, CO (US); Rosemarie Livigni, Louisville, CO (US); Russell Edward Mandel, Bethel, CT (US); Mark P. Meredith, Marietta, GA (US); Lynne M. Salinkas, Lafayette, CO (US)

Correspondence Address: HESLIN ROTHENBERG FARLEY & MESITI PC, 5 COLUMBIA CIRCLE, ALBANY, NY, 12203, US

(73) Assignee: International Business Machines Corporation, Armonk, NY

(21) Appl. No.: 10/621,750

(22) Filed: Jul. 17, 2003

Related U.S. Application Data
(63) Continuation-in-part of application No. 10/002,023, filed on Oct. 18, 2001, now abandoned.
Application No. 10/002,023 is a continuation-in-part of application No. 09/668,209, filed on Sep. 22, 2000, now abandoned.
Application No. 09/668,209 is a continuation-in-part of application No. 09/406,063, filed on Sep. 27, 1999, now abandoned.

(51) Int. Cl. G09B 19/18

(52) U.S. Cl. 434/107

(57) ABSTRACT

Methods are presented for improving performance within an organization, including enhancing sales or service productivity of members of the organization. Desired characteristics for the organization are initially ascertained from the perspective of customers of the organization. Leaders are then employed to define cultural characteristics for the organization using, in part, the desired characteristics, and to define the cultural characteristics in behavioral terms. Action plans are generated for changing the organization to implement the defined cultural characteristics not already present and diminish present characteristics that are inconsistent with the defined cultural characteristics. Leaders of the organization validate the cultural characteristics and the action plan with a focus group including managers within the organization. Owners for implementing the action plans are assigned and progress in implementing the plans is measured.

### CROSS-REFERENCE TO RELATED APPLICATIONS

This application is a continuation-in-part of U.S. patent application Ser. No. 10/002,023, filed Oct. 18, 2001, which is a continuation-in-part of U.S. patent application Ser. No. 09/668,209, filed Sep. 22, 2000, which is a continuation-in-part of U.S. patent application Ser. No. 09/406,063, filed Sep. 27, 1999. Each of these applications is hereby incorporated herein by reference in its entirety.

### TECHNICAL FIELD

The invention relates generally to methods of improving an organization, and in particular, to improving through change the productivity of an organization such as a sales providing organization or service providing organization, for example, in the computer technology or computer information technology fields.

### BACKGROUND OF THE INVENTION

The background of this invention is described below with reference to service providing organizations. However, similar problems exist for sales providing organizations as well.

Service organizations provide many of the resources needed to operate businesses. For example, an information technology organization may provide services such as workstation selection, procurement, configuration, interconnection, and maintenance. It may also provide software support, help desk operation, user training and many other services associated with information technology used in a business. The service organization may be internal to the business itself, or it may be a completely independent business which provides such services on a contract basis. Providing such services has become a very profitable and competitive area of endeavor. However, in order to remain competitive it is desirable that the productivity of the service providing organization be optimized.

One factor which directly effects the productivity of any organization is the performance technique implemented by the employees and other members of the organization. See S. Robbins in Organizational Behavior, Prentice Hall, New Jersey, 1998 ISBN 0-13-587459-6. Performance techniques are a set of key characteristics that the organization values. S. Robbins describes on pages 595-596 the performance technique characteristics shown in Table I.

TABLE I
Characteristics

The level of innovation and risk taking
The expectation to demonstrate attention to detail
The focus on results rather than techniques or processes used to achieve
these results
The level of consideration of the effect of results on the people in the
organization
The level at which work is performed by a team orientation rather than by
individuals working separately
The level of aggressive and competitive rather than easygoing behavior
The emphasis on activities which maintain stability vs. growth

These characteristics represent a shared understanding of how things are done in an organization and how the members or employees are expected to behave.

Many existing organizations have not developed a high performance service technique. Unfortunately it is difficult and time consuming to change an existing performance strategy. In fact, S. Robbins indicates that a crisis may be required to change an organization's performance strategy.

Other authors have proposed processes for improving performance but invariably comment on the great difficulty or impossibility of causing such changes. Connor, D. in Leading at the edge of chaos, John Wiley, 1998, p.88, Deal, T. E. and Kennedy, A. A. In Corporate cultures page 175-176, Stein, E. H. in Organizational culture and leadership pp. 304-305, Cotter, J. P. in “Leading change: Why Transformation Efforts Fail,” of Harvard Business Review, March-April 1995 pp. 59-67, Carr, D. K. in Managing the Change Process pp.144-145 and 147-149, all describe such processes and difficulties, and are incorporated herein by reference.

### SUMMARY OF THE INVENTION

According to one aspect, the present invention comprises a method of effecting improvement of an organization. The method includes: ascertaining through research with customers of the organization desired characteristics for the organization from the customer perspective; employing leaders of the organization to define cultural characteristics for the organization using, at least in part, the desired characteristics ascertained through research with customers of the organization; defining the cultural characteristics in behavioral terms; identifying defined cultural characteristics which are not already present in the organization or present characteristics of the organization which are inconsistent with the defined cultural characteristics; generating at least one action plan for changing the organization to implement the defined cultural characteristics within the organization and diminish any identified present characteristics inconsistent with the defined cultural characteristics; and employing at least one leader of the organization to validate the cultural characteristics expressed in behavioral terms and the at least one action plan with at least one organization focus group comprising, at least in part, managers within the organization; and once validated, implementing the at least one action plan across at least some managers and members of the organization and measuring progress in implementing the plan.

In another aspect, a method is provided which includes: obtaining cultural characteristics of an organization expressed in behavioral terms; training a recruiter for the organization on the cultural characteristics of the organization; during an interview with an applicant, having the recruiter describe the cultural characteristics of the organization; asking the applicant to relate past educational or employment behavior to the cultural characteristics of the organization; and hiring the applicant if, in part, there is a sufficient degree of match between the applicant's prior educational or employment behavior and the cultural characteristics of the organization.

In a further aspect, a method of effecting improvement of an organization is presented. This method includes: defining cultural characteristics for an organization; developing shared executive norms for leaders of the organization comprising behavioral expressions for the leaders of the defined cultural characteristics; implementing the shared executive norms among at least some leaders of the organization for a period of time; subsequent to the implementing, generating at least one action plan for changing the organization to implement the defined cultural characteristics within the organization and diminish any present characteristics inconsistent with the defined cultural characteristics; employing at least one leader of the at least some leaders implementing the shared executive norms to validate the at least one action plan with at least one focus group comprising at least in part, effected managers or members of the organization; and once validated, implementing the at least one action plan across at least one portion of the organization.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flowchart of one embodiment of a process for effecting improvement in an organization, in accordance with an aspect of the present invention;

FIG. 2 depicts a cultural implementation model 200 useful in describing certain aspects of the process of FIG. 1, in accordance with an aspect of the present invention;

FIG. 3 is a flowchart of another embodiment of a process for effecting improvement in an organization, in accordance with an aspect of the present invention; and

FIG. 4 is a flowchart of still another embodiment of a process for effecting improvement in an organization, in accordance with an aspect of the present invention.

### BEST MODE FOR CARRYING OUT THE INVENTION

As used herein, a company may comprise one organization or multiple organizations, including both one or more service providing organizations and one or more sales providing organizations.

A high performance organization has high productivity, which leads to business success, customer satisfaction and profitability. Some of the characteristics of a high performance service or sales approach include a high degree of customer insight, drive to achieve, team leadership, straight talk, teamwork as a result of business focus, building organizational capability, and coaching.

Sales providing and service providing organizations may find it desirable to reengineer their culture to redefine organizational systems and structures. Processes such as described herein to align an organization to desired cultural characteristics and behaviors will facilitate insuring the acceptance of these changes, thereby minimizing chances that the reengineering effort will be less successful and/or unsustainable.

Generally stated, in one aspect a novel approach to reconfiguring an organization, including defining cultural characteristics expressed in behavioral terms, is presented herein. This approach, in part, begins with ascertaining of desired characteristics for the organization from a customer perspective, for example, through customer research or a voice of the customer study. This customer research is then used by leadership of the organization to define cultural characteristics for the organization, which are then expressed in behavioral terms. An action plan is defined where necessary to implement the cultural characteristics and the leadership itself validates the cultural characteristics and action plan with a focus group comprising managers and other select employees of the organization. Note that this approach to reengineering the culture of the organization begins from the viewpoint of the customers of the organization, and largely depends upon the input and direction provided by the leadership of the organization using the input from the customers.

The concepts described herein can be applied to various types of organizations, such as service providing organizations and sales providing organizations, for improving performance of the organization; that is, for improving productivity of members of the organization or productivity of the overall organization itself. As one example, the organization may be a service providing organization which provides information technology services, or a sales providing organization which provides computer technology sales, but can also be other types of business organizations or any other organization having members who are natural persons. For reasons of clarity of explanation, the figures provided herein show a sequence; however, it is not necessary that all processes be done in a particular order to practice aspects of the present invention.

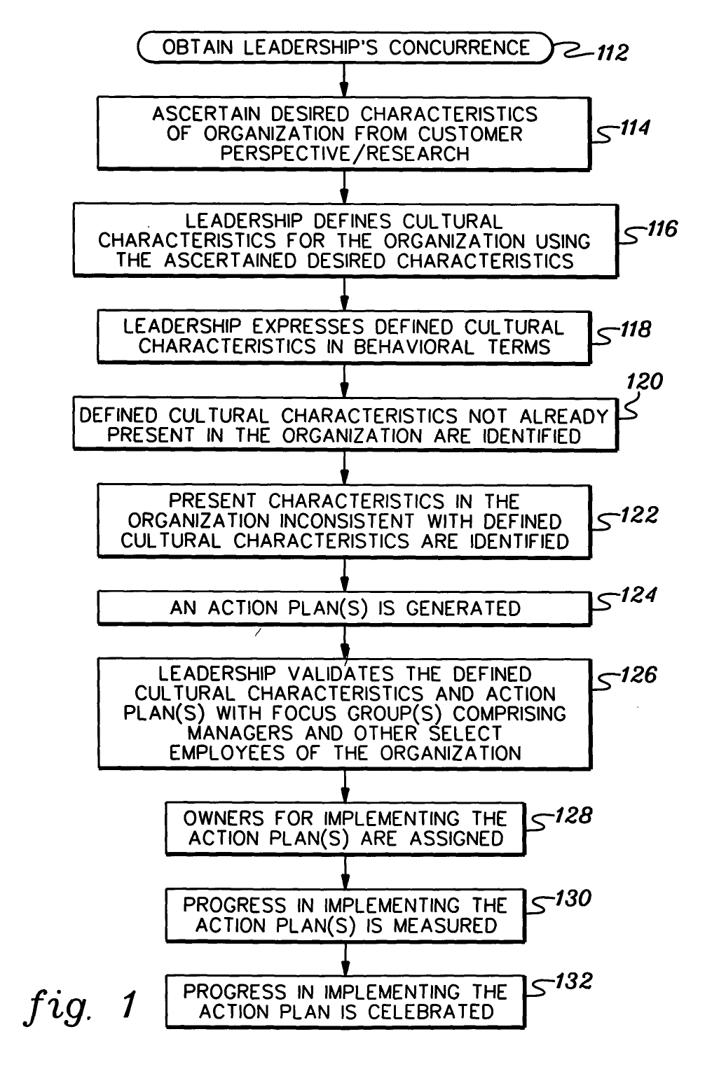

The processing of FIG. 1 begins with obtaining concurrence by one or more leaders of the organization to, for example, improve productivity of certain members, a subgroup of the organization, or the entire organization itself 112. Typically, the one or more leaders would be members, as well as leaders of the organization. By obtaining this concurrence, the readiness of the one or more leaders for other changes in the organization is established, which will facilitate the bringing about of the desired changes.

Next, characteristics are defined as desired characteristics for the organization 114. These desired characteristics can be thought of as desired states for the organization and they are obtained from the perspective of the customers of the organization, for example, through appropriate customer workshops and/or voice of the customer studies. For example, the desired characteristics for the organization are obtained by inquiring of the customers what the customers would like to see from the organization, whether the organization is a service providing organization or a sales providing organization. These characteristics are highly valued characteristics from the perspective of the customers of the organization. Once the desired characteristics for the organization are assembled from the customer perspective, then the leaders of the organization begin to define cultural characteristics for the organization using, in part, the desired characteristics ascertained from the customers. This approach is believed to be a departure from prior approaches which typically define themselves internally as to their desired characteristics.

The leaders of the organization then define cultural characteristics for the organization using the ascertained desired characteristics 116. Culture of an organization is a set of spoken and unspoken shared values, expectations and experiences that define, shape and reinforce the way the organization behaves over time. One effected population for a culture would be all members of the organization that are customer facing and/or have direct revenue-generating responsibility.

Once the cultural characteristics are defined for the organization, then leadership (in one example) expresses the defined characteristics in behavioral terms 118. By requiring leadership to define the cultural characteristics and express those characteristics in behavioral terms, the leaders are more likely to accept the changes desired for the organization. Table II depicts one example of sales cultural characteristics for a sales providing organization. Within Table II, the cultural characteristic is initially identified, and then followed by the more detailed behavioral term(s) defining the characteristic.

TABLE II
Sales Cultural Characteristics - Definitions

Are customer-focused
We understand our customers' business and industry. We understand our
customers' climate. We understand our customers as people. We listen and
relate our customers' opportunities and initiatives to organization
solutions - adding value at every engagement.
Leverage and integrate team organization
We serve our customers and “sell the whole portfolio” by leveraging and
integrating the full range of organizational resources, including our face to
face sales force, business partners, and organization.com channels. We
provide our customers a seamless interface that makes the organization
easy to do business with.
Celebrate accomplishments
We consistently recognize team and individual winners and successes.
Take pride and have passion for the organization's technology and services
We convey our pride in the organization's current and future technology
and services. We are passionate about providing organizational solutions
to our customers (and our technology pulls clients to us).
Are proud, confident, and successful, supported by the entire organization
We join and thrive with the organization because our environment
reinforces the sense of community that enables our sales success. We feel
valued and acknowledged for our contribution to the organization.
Are driven to win: focused, tenacious, and passionately competitive
We are recognized as the best sales professionals in the industry. We are
goal-oriented and laser-focused, driven by a sense of urgency and in-
telligent risk taking, resulting in a high level of commitment, creative
contribution and achievement.

By expressing the cultural characteristics in specific behavioral terms, the characteristics can be more readily observed and measured. Some organizational systems and structures that drive behavior are: Communications, Training and/or Orientation, Leader Modeling Behaviors, Performance/Review Systems, Policies, Procedures/Plans, Budgets and Constituency Results. Examples of the resulting observable behaviors are good attitude, responsiveness, flexibility, accessibility, open communication, do what you say, urgency, and sharing resources.

Those cultural characteristics defined by the leadership that are not already present in the organization are identified 120, and present characteristics in the organization which are inconsistent with, in conflict with, or otherwise incompatible with the defined cultural characteristics are also identified 122.

Having made these identifications, one or more action plans are devised 124 to promote the development of the desired cultural characteristics not already present and diminish any present characteristics which are inconsistent with the desired cultural characteristics. Action plans may include, but are not limited to, changing an award system, changing an employee rating program, performing promotional planning, taking an employee moral survey, or acquiring skills through training or education. Generating the one or more action plans can include: (1) defining an explicit action; (2) determining how to measure success or progress; and (3) determining how to implement the action plan(s) to insure success.

One or more focus groups are used by leadership to validate the defined cultural characteristics and action plans. This validation includes presentation of the cultural characteristics and action plans by the leadership of the organization, and the selection of the focus group to include individuals who are managers and other critical, constructive members of the organization 126. Before presenting before the focus group(s), the leaders of the organization are trained to conduct the focus session and explain the defined cultural characteristics, and the one or more action plans. This action by itself helps to heighten awareness of the reengineering effort in the leaders of the organization, and by requiring that the focus group be comprised of, for example, first line managers of the organization, then the majority of effected leaders and managers essentially buy into the changes before implementation is attempted. Validation of the cultural characteristics and action plans may include modifying the characteristics and/or action plans by tuning and prioritizing, for example, to close any gaps identified by the focus groups.

Examples of actions that may be taken to implement a defined cultural characteristic in a sales providing organization may include, for example, those set forth in Table III.

TABLE III
Actions to be taken

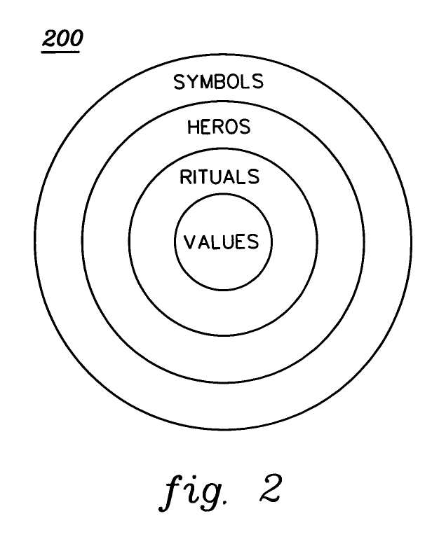

Recognize every seller who achieves 100% of quota with a letter from
appropriate Brand General Manager (Symbol) (See FIG. 2)
Evaluate recognition events/programs (Rituals)
Evaluate criteria and design
Recognition to be equitable across the sales community
Insure event/program is appropriate for achievement
Determine recognition program going forward
Use of Sales Leaders as “Heroes”
Schedule key sales executives to participate in ALL sales education
programs
Develop consistent message for them to use to support desired sales
cultural characteristics.
Develop celebration program for mobile environment (Symbols and
Rituals)
Benchmark externally for ideas (what do competitors recognize as success
and how do they celebrate success).
Design program/ideas appropriate for organization's workforce.
Execute Communications Strategy focusing on culture impact
Drumbeat of inspirational messages on Values and Behaviors to entire
sales community.
Sales Profession Redesign (Heroes)

FIG. 2 depicts one example of how action plans may be broken down for a particular organization. In this example, the central Values equate to the desired cultural characteristics, while the Rituals, Heroes and Symbols served to reinforce those cultural characteristics. Examples of Rituals might include creating a sales club which is attained by sales employees using clear and measurable goals and having quarterly rallies for sales employees. Heroes could be defined as a select group of members of the organization which are considered well known in the industry for their expertise, essentially creating an industry masters program. Sales Olympians could be identified that would allow top performers to continually raise the level of their achievement. A perks package could be included for sales Olympians depending upon medals awarded. The package could include a sales coach, financial incentive and/or community support. Symbols could be employed to, for example, promote a winning attitude and celebrate and recognize sales employees.

Continuing with FIG. 1, after validation of the action plan(s), owners for implementing the resulting plans are assigned 128. The owners are preferably managers/members of the organization and more preferably, managers/members of the focus groups, who have already been exposed and contributed to defining the action plan(s).

Progress in implementing the action plans is measured 130 and, optionally, celebrated 132. Typical measures of progress may include, percent completion, on or behind schedule, over/under budget, etc. Celebrations of progress serve to reinforce and recognize progress in bringing about the changes needed to cause the performance improvement. There is no particular number, type, or frequency of celebration required, however, a celebration is preferably held frequently enough to help maintain the momentum of the overall performance improvement process.

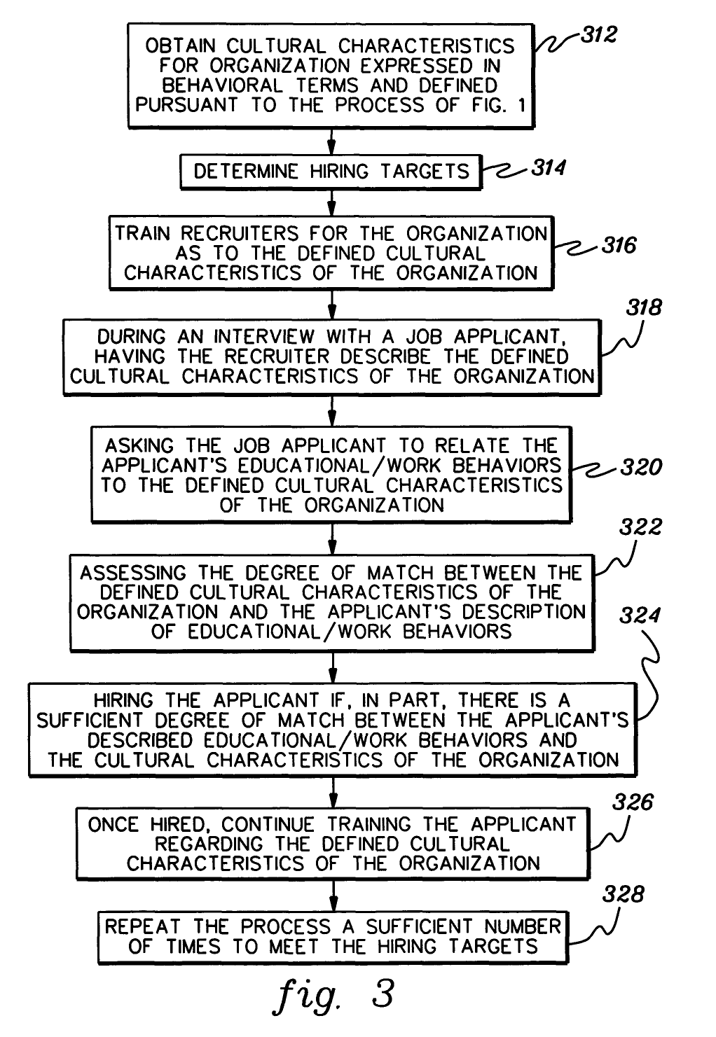

FIG. 3 depicts another embodiment of a process for effecting improvement in an organization, in accordance with an aspect of the present invention. This process includes obtaining cultural characteristics for the organization expressed in behavioral terms 312. These cultural characteristics are defined from the perspective of customers of the organization, in one embodiment, pursuant to the processing of FIG. 1. Hiring targets may next optionally be determined 314. Hiring targets may be determined by examining industry trends such as growth patterns or other trends, or based on anticipated workload for the organization. Other methods of determining hiring targets known in the recruiting or other arts may be used.

Recruiters for the organization are trained on the defined cultural characteristics of the organization 316. The object of training the recruiters on the cultural characteristics of the organization is to facilitate a subsequent discussion with an applicant around the culture of the organization, i.e., the culture within which the potential hiree would be working. This discussion is distinct from a description of specific job characteristics or requirements for the applicant to meet. The purpose of having a discussion around the culture of the organization is to ensure alignment between the applicant's behaviors and the culture of the organization.

Thus, during an interview with a job applicant, the recruiter describes the defined cultural characteristics of the organization to initiate a discussion with the applicant for the above-noted purpose 318. To facilitate this discussion, the applicant is asked to relate examples the applicant's past educational and/or employment behavior to the defined cultural characteristics of the organization 320. More particularly, the interviewer may describe to the applicant the culture of the organization and give specific behavioral examples of the culture. The job applicant is then requested to relate examples of the applicants' past educational and/or employment behaviors or life experiences to the cultural characteristics of the organization as a means of facilitating an assessment of the degree of cultural matching between the applicant and the organization.

For example, one cultural characteristic of the organization may be that the organization approaches customers with new solutions and not just off the shelf answers to a customer's problem. Thus, the organization is looking for applicants who can initiate creative approaches, rather than simply repeat rote answers. The job applicant is requested to provide behavioral examples where the applicant had, for example, to approach a customer from a new perspective. This discussion helps to calibrate for the interviewer how the applicant can relate his/her past experiences to the cultural characteristics of the organization. As another example, one cultural characteristic of the organization may be that the organization works closely together as a team, with all members being interdependent. Conversely, if the job applicant is independent and prefers to work alone, then a good dialog is had during the interview process regarding whether this would be the best opportunity for the applicant to continue to pursue. This discussion of the cultural characteristics of the organization or values of the organization and asking the applicant to relate past examples which may match those cultural characteristics is different from, and in addition to, describing for the applicant the requirements for a given position and evaluating the applicant's past educational and/or employment experiences which would qualify the applicant for that position. Note that the examples of the applicant's past educational and/or employment behavior can be obtained either verbally during the interview or in written form either during the interview or subsequent to the interview.

The degree of match between the defined cultural characteristics of the organization and the applicant's description of educational and/or work behavioral examples is then assessed 322 and the applicant is hired if, in part, there is an acceptable degree of match between the applicant's described educational and/or work behavior and the cultural characteristics of the organization 324. Once hired, the applicant's training is continued in order to further reinforce the defined cultural characteristics of the organization 326. The interviewing and assessing process is repeated until a sufficient number of applicants are hired to meet the optionally set hiring targets 328. Again, with each new hire, training about the cultural characteristics of the organization is continued. This training may include a corporate level class such as one attended by all new applicants on their first working day. The corporate level class may include training in subjects common in core to all applicants hired corporate wide. The training may be taken at a single corporate location or at various field locations.

Training may also include meeting with a manager to review a master checklist covering various topics and information that the newly hired applicant will need to know to work at a specific assigned department. The applicant may also be trained by taking a solutions operations class directed to the organization having the defined cultural characteristics. For a particular information technology service or sales organization, this solutions operations class may include training and customer support services, distributed services/sales, e-business delivery services/sales, or enterprise services/sales.

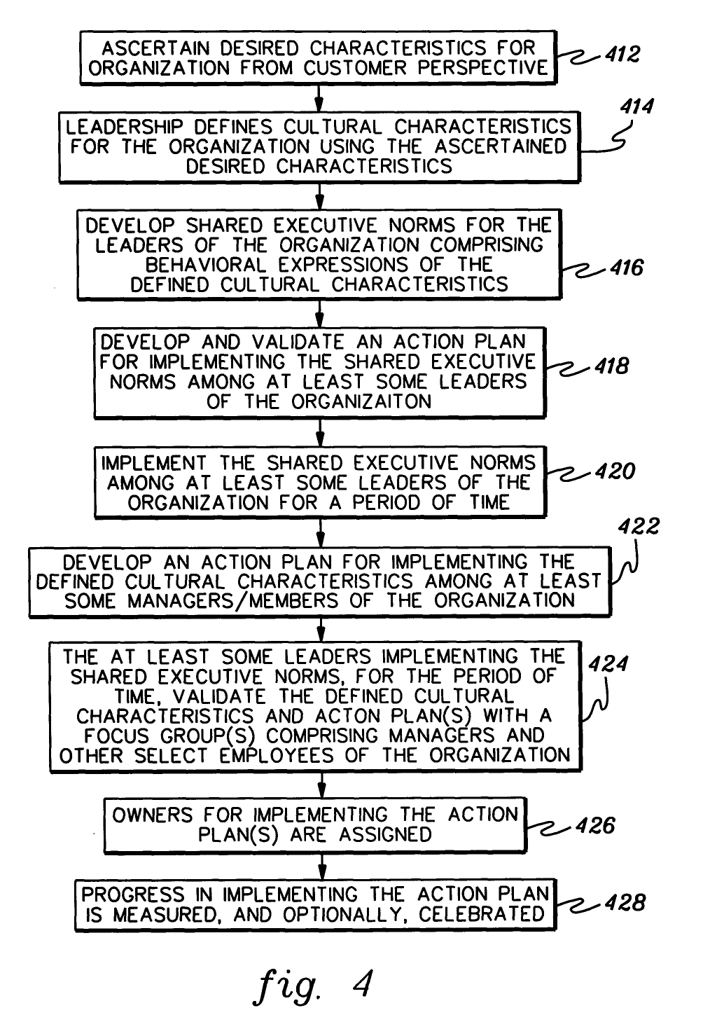

FIG. 4 depicts still another embodiment of a process for effecting improvement in an organization, in accordance with an aspect of the present invention. This process is a variation on the process depicted in FIG. 1. Initially, desired characteristics for an organization are ascertained from the perspective of a customer of the organization 412. Although not required, the perspective of the customer could be expressly ascertained through appropriate customer workshops and/or voice of the customer studies. Alternatively, leadership of the organization could in a workshop employ brainstorming techniques to identify desired characteristics from the customer's perspective. Note that in the process of FIG. 4, the organization is assumed to be sufficiently large to have a plurality of leaders who provide direction to members of the organization. In many organizations, managers may be interposed between the leaders and the members. By way of example, the organization may be a service providing or sales providing organization which provides information technology services or sales, but can also be any type of business organization or any other organization having members who are natural persons.

Next, leadership defines cultural characteristics for the organization using, at least in part, the ascertained desired characteristics 414. Again, the cultural characteristics for an organization comprises a set of spoken and unspoken shared values, expectations and experiences that define, shape and reinforce the way the organization behaves over time. One effected population for a cultural characteristic would be all members of the organization that are customer facing and/or have direct revenue-generating responsibility.

From these cultural characteristics, shared executive norms for leaders of the organization are developed 416. These shared executive norms comprise behavioral expressions of the defined cultural characteristics, and are in particular, behavioral expressions for the leadership of the organization. The shared executive norms may again be created in a workshop attended by leaders of the organization. The workshop may use divergent or convergent brainstorming techniques to assist in creating the executive norms.

Once the shared executive norms are developed, an action plan may optionally be developed and validated for implementing the shared executive norms among at least some leaders of the organization 418. Development of the action plan could include identifying shared executive norms not already present in the organization and present leadership norms in the organization inconsistent with defined shared executive norms. Once an action plan is generated, then the plan can be validated using, for example, a focus group comprising leaders and other select employees of the organization.

Whether an action plan is developed and validated, or not, the shared executive norms are next implemented among at least some leaders of the organization for a period of time 420. Although the period of time can vary, one example might be 3-6 months of time where only the leaders of the organization are implementing the shared executive norms. Thus, in accordance with this process, the leadership of the organization employs the cultural characteristics expressed as shared executive norms before the cultural characteristics are ever propagated throughout the organization. This action forces the leadership of the organization to accept ownership of the characteristics by modeling the shared executive norms, thereby forcing the leadership to initially accept and actually live by the defined cultural characteristics for the organization before those cultural characteristics are attempted to be propagated across the organization. Thus, in accordance with this process, the shared executive norms, i.e., behavioral expressions of cultural characteristics for the leaders, are actually practiced by the leaders before they are made “public” within the organization as the organization's cultural characteristics. This advantageously improves the likelihood that the cultural characteristics will take root within the organization rather than being perceived as simply another company imposed program.

Once at least some leaders of the organization have implemented the shared executive norms for a reasonable length of time, then an action plan is developed for implementing the defined cultural characteristics among at least some managers and/or members of the organization 422. This action plan may be proceeded by defining the cultural characteristics in behavioral terms for the managers and/or members of the organization. Subsequently, one or more leaders of the at least some leaders implementing this shared executive norms for the period of time proceed to validate the defined cultural characteristics and action plan(s) with a focus group(s) comprising managers and other select members of the organization 424. Thereafter, owners for implementing the action plan(s) within the organization are assigned 426 and progress in implementing the action plan can be measured, and optionally, celebrated 428.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of effecting improvement of an organization comprising:
ascertaining through research with customers of the organization desired characteristics for the organization from a customer perspective;
employing at least one leader of the organization to define cultural characteristics for the organization using, at least in part, the desired characteristics ascertained through research with the customers of the organization;
defining the cultural characteristics in behavioral terms;
identifying defined cultural characteristics which are not already present in the organization or present characteristics of the organization which are inconsistent with the defined cultural characteristics;
generating at least one action plan for changing the organization to implement the defined cultural characteristics within the organization and diminish any identified present characteristics inconsistent with the defined cultural characteristics;
employing at least one leader of the organization to validate the cultural characteristics expressed in behavioral terms and the at least one action plan with at least one focus group comprising, at least in part, managers within the organization; and
once validated, implementing the at least one action plan across at least a portion of the organization.

2. The method of claim 1, further comprising assigning individuals within the organization to implement the at least one action plan among at least some members of the organization, and wherein the effecting improvement of the organization comprises enhancing productivity of members of the organization.

3. The method of claim 2, wherein the enhancing productivity of members comprises enhancing at least one of sales productivity or service productivity of members of the organization.

4. The method of claim 1, wherein the employing at least one leader to define the cultural characteristics in behavioral terms comprises employing at least one leader to define the cultural characteristics as desired sales behavioral characteristics.

5. The method of claim 1, wherein the at least one leader comprises at least one senior sales leaders of the organization, and the managers comprise first line managers of sales members of the organization.

6. A method comprising:
obtaining cultural characteristics for an organization expressed in behavioral terms;
training a recruiter for the organization on the cultural characteristics of the organization;
during an interview with an applicant, having the recruiter describe the cultural characteristics of the organization;
asking the applicant to relate past education or employment behavior to the cultural characteristics of the organization; and
hiring the applicant if, in part, there is a sufficient degree of match between the applicant's described past education or employment behavior and the cultural characteristics of the organization.

7. The method of claim 6, wherein said obtaining cultural characteristics for the organization comprises ascertaining through research with customers of the organization desired characteristics for the organization from a customer perspective, and employing at least one leader of the organization to define cultural characteristics for the organization using, at least in part, the desired characteristics ascertained through research with customers of the organization.

8. The method of claim 7, wherein said obtaining cultural characteristics further comprises employing at least one leader of the organization to validate the cultural characteristics expressed in behavioral terms with at least one organization focus group comprising, at least in part, managers within the organization.

9. The method of claim 6, further comprising assessing a degree of match between the applicant's described education or employment behavior and the cultural characteristics of the organization, and wherein said hiring comprises hiring the applicant if, in part, the degree of match is acceptable.

10. The method of claim 6, wherein the organization is at least one of a sales providing organization or a service providing organization.

11. The method of claim 6, further comprising determining hiring targets for the organization, and wherein said hiring further comprises hiring enough applicants having an acceptable degree of match using said method to meet the hiring targets.

12. The method of claim 6, further comprising, after hiring the applicant, further training the applicant about the cultural characteristics of the organization.

13. The method of claim 12, wherein said training comprises at least one of taking a corporate level class, reviewing a master checklist, or taking a solutions operations class.

14. The method of claim 13, wherein the solutions operations class includes training in customer support services, distributed services, e-business delivery services and enterprise services.

15. A method of effecting improvement of an organization comprising:
defining cultural characteristics for an organization;
developing shared executive norms for leaders of the organization comprising behavioral expressions for the leaders of the defined cultural characteristics;
implementing the shared executive norms among at least some leaders of the organization for a period time;
subsequent to said implementing, generating at least one action plan for changing the organization to implement the defined cultural characteristics within the organization and diminish any present characteristics inconsistent with the defined cultural characteristics;
employing at least one leader of the at least some leaders implementing the shared executive norms to validate the at least one action plan with a focus group comprising managers or members of the organization; and
once validated, implementing the at least one action plan across at least a portion of the organization.

16. The method of claim 15, wherein said defining comprises ascertaining through research with customers of an organization desired characteristics for the organization from a customer perspective, and employing, at least one leader of the organization to define the cultural characteristics of the organization using, at least in part, the desired characteristics ascertained through research with the customers of the organization.

17. The method of claim 15, further comprising, prior to said implementing, developing at least one action plan for implementing the shared executive norms among at least some leaders of the organization, and wherein said implementing comprises employing said at least one action plan in implementing the shared executive norms among the at least some leaders of the organization for the period of time.

18. The method of claim 17, further comprising, prior to said implementing, validating the action plan for implementing the shared executive norms, said validating being performed using a focus group comprising leaders of the organization.

19. The method of claim 15, wherein said implementing comprises implementing the shared executive norms among at the least some leaders of the organization for at least several months prior to proceeding with generating of an action plan for changing the organization to implement the defined cultural characteristics across the organization.

20. The method of claim 15, further comprising prior to generating the at least one action plan, identifying defined cultural characteristics which are not already present in the organization or present characteristics of the organization which are inconsistent with the defined cultural characteristics.

21. The method of claim 15, further comprising measuring progress in implementing the at least one action plan across the at least one portion of the organization.

22. The method of claim 15, wherein the effecting improvement of the organization comprises enhancing productivity of members of the organization, and wherein the enhancing productivity of members comprises enhancing at least one of sales productivity or service productivity of members of the organization.
